(19) United States
(12) Patent Application Publication
(10) Pub. No.: US 2026/0119691 A1
(43) Pub. Date: Apr. 30, 2026

(54) OPTIMIZING BUSINESS CONTINUITY FOR EDGE COMPUTING ENVIRONMENTS

(71) Applicant: Dell Products L.P., Round Rock, TX (US)

(72) Inventors: IGOR DUBROVSKY, Beer Sheva (IL); BORIS SHPILYUCK, Ashdod (IL); MAXIM BALIN, Gan-Yavne (IL); STAV SAPIR, Beer Sheva (IL)

(21) Appl. No.: 18/931,990

(22) Filed: Oct. 30, 2024

(51) Int. Cl. G06F 21/62; G06F 16/28

(52) U.S. Cl. CPC G06F 21/6218; G06F 16/285

(57) ABSTRACT

Methods and systems for managing systems are disclosed. To manage the systems, continuity policies may be established based on data importance and sensitivity, as well as capabilities of continuity sites. During operation of the system, conditions impacting production sites may be monitored for events identified by the continuity policies. When such an event is identified, remedial activity specified by the continuity policy may be performed to improve the likelihood of continued provisioning of computer implemented services.

### FIELD

Embodiments disclosed herein relate generally to system management. More particularly, embodiments disclosed herein relate to systems and methods to manage continuity of services provided by distributed systems subject to disruption in operation.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIG. 3 shows a flow diagram illustrating a method of providing computer implemented services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of distributed systems. The distributed systems may provide desired computer implemented services using various portions of data.

To improve the likelihood of computer implemented services being provided over time, continuity sites may be used as backup for production sites that initially provide the computer implemented services. When a production site is unable to (or likely to be unable to in the future) provide the computer implemented services, continuity policies for the production sites may indicate workflows to be performed to restore provisioning of the computer implemented by corresponding continuity sites.

The continuity policies may include targets (e.g., continuity sites) that are selected in a manner that both mitigates potential security risks and improves desirability of the computer implemented services. The targets may be selected based on importance and sensitivity of data used in the services, and characteristics of the continuity sites.

By doing so, a system in accordance with an embodiment may be more likely to provide desired computer implemented services by proactively preparing for occurrences of events that may disrupt the operation of production sites. Thus, embodiments disclosed herein may address, among others, the technical problem of disruptions in distributed systems that may deprive some of the system from being able to contribute to the computer implemented services. The disclosed embodiments may do so by tailoring continuity targets to both the services that are provided by production sites (and corresponding sensitivity/importance of data used in the services) and capabilities of the continuity sites.

In an embodiment, a method for managing a distributed system is provided. The method may include obtaining an importance classification for at least a portion of data stored in a production site; obtaining data suitability scores for a plurality of continuity sites; obtaining a continuity policy for the portion of the data based on at least the importance classification and the data suitability scores; identifying, based on the continuity policy, an occurrence of an event impacting the production site that provides computer implemented services; and, based on the event, using, based on the continuity policy, the continuity site to continue provisioning of the computer implemented services while the event limits ability of the production site to provide the computer implemented services.

Obtaining the data suitability scores may include, for a continuity site of the plurality of continuity sites: obtaining an estimated level of latency for data access in the continuity site; obtaining an estimated level of bandwidth for the data access in the continuity site; obtaining an estimated level of capability to provide the computer implemented services by the continuity site; and combining the estimated level of latency, the estimated level of bandwidth, and the estimated level of capability to obtain a data suitability score of the data suitability scores.

The method may also include obtaining a sensitivity classification for the at least the portion of data stored in a production site, the sensitivity classification indicating a level of penalty for an owner of the distributed system should the portion of the data be accessed by unauthorized entities.

The importance classification for the at least the portion of the data may indicate an extent to which the computer implemented services would be disrupted when the at least the portion of the data is inaccessible.

The continuity policy may indicate a destination for re-establishing performance of the computer implemented services following the event.

The continuity policy may further indicate at least one action to be performed prior to the occurrence of the event and in response to an occurrence of a second event, the second event may indicate an increased likelihood of the occurrence of the event in the future.

The method may also include grouping the plurality of continuity sites into groups based on the data suitability scores.

Obtaining the continuity policy may include identify a group of the groups based on at least the importance classification; selecting one of the plurality of continuity sites grouped in the group; and adding the one of the plurality of continuity sites to the continuity policy as a target restoration location.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

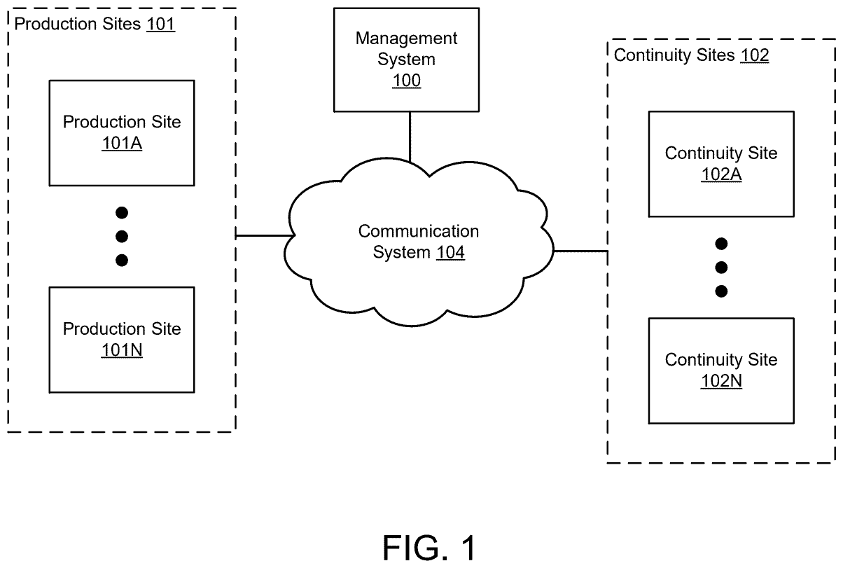

Turning to FIG. 1, a block diagram illustrating a system in accordance with an embodiment is shown. The system shown in FIG. 1 may provide computer-implemented services. The computer-implemented services may include data management services, data storage services, data access and control services, database services, and/or any other types of services that may be provided with a computing device.

To provide the computer implemented services, the computing devices may include various hardware components that may generate, send, receive, and use data over time. To be able to provide the computer implemented services, the computing devices may need to operate in predetermined manners.

For example, the computing devices may need to be able to execute programs, store data, communicate with other entities, and/or perform other operations. If the computing devices are unable to perform these functionalities, then the computer implemented services may not be able to be provided.

Various causes such as natural disaster, cyberattacks, failures of hardware components, etc. may prevent the computing devices from performing these functionalities. For example, a hurricane or other type of natural disaster may destroy computer hardware, knock out power, or otherwise impact a computing environment which may prevent the computing environment from providing desired computer implemented services.

In general, embodiments disclosed herein may provide methods, systems, and/or devices for improving the likelihood of being able to provide computer implemented services over time. To improve the likelihood, continuity policies may be established and enforced when systems are unable to perform their functionalities necessary for provisioning of computer implemented services (and/or in advance of events that may lead to such outcomes).

To establish the continuity policies, sensitivity of data, importance of data, and capabilities of potential continuity sites may be analyzed to establish the continuity policies. During the analysis, the capabilities of the continuity site may be used to group the continuity sites into different tiers. For each existing production site where portions of data reside, the sensitivity and/or importance of the respective portions may be used to select one of the groups for the existing site. Then, a corresponding continuity policy may be established that indicates that functionality of the existing production site should be restored using one of the continuity sites from the selected group. In this manner, the continuity policies may be established in a manner that matches capabilities of continuity sites with needs of data used in existing sites and hedges against potential exposure of the data by the continuity sites.

Once the continuity policies are established, the operation of the system may be updated over time based on the continuity policies by (i) reactively responding to events based on the policies and/or (ii) proactively mitigation potential harm due to the vent based on the policies.

Thus, embodiments disclosed herein may improve the likelihood that desired computer implemented services are provided over time. The disclosed method may do so by establishing continuity policies that manage undesired access of data which may be caused when data from an existing production site is migrated to a less secure continuity site. Accordingly, the resulting continuity workflows may enable continued provisioning of computer implemented services while hedging risk in migration of workloads between sites.

To provide the above noted functionality, the system of FIG. 1 may include management system 100, production sites 101, continuity sites 102, and communication system 104. Each of these components is discussed below.

Production sites 101 may include computing environments that provide desired computer implemented services. The computing environments may be any type of computing environment (e.g., data center, edge deployment, cloud computing environment, etc.). Each production site (e.g., 101A-101N) may include any number of data processing systems that may cooperatively and/or in isolation provide the computer implemented services. Any of the productions site may cooperate with other production sites or operate independently from other production sites.

In an embodiment, each of productions sites 101 is in a separate fault domain. Accordingly, it may be unlikely for multiple production sites to fail contemporaneously due to a common cause.

Continuity sites 102 may, like production sites 101 include computing environments that provide desired computer implemented services. The computing environments may be any type of computing environment (e.g., data center, edge deployment, cloud computing environment, etc.). Each continuity site (e.g., 102A-102N) may include any number of data processing systems that may cooperatively and/or in isolation provide the computer implemented services. Any of the continuity site may cooperate with other continuity sites or operate independently from other continuity sites.

In an embodiment, each of continuity sites 102 is in a separate fault domain. Accordingly, it may be unlikely for multiple continuity sites to fail contemporaneously due to a common cause. Likewise, any of continuity sites 102 may be separate fault domains from production sites 101. Therefore, all, or a portion, of continuity sites 102 may be unlikely to fail contemporaneously and for similar causes resulting in failures of production sites 101.

Management system 100 may manage operation of production sites 101 and continuity sites 102. To do so, management system 100 may (i) obtain information regarding data used by production sites 101, (ii) obtain information regarding capabilities of continuity sites 102, (iii) group continuity sites 102 based on the respective capabilities, (iv) establish continuity policies based on the groupings and information regarding the data used by production sites 101 to mitigate impacts of failures of production sites 101, (v) perform various actions to be prepare to address issues impacting production sites 101 such as, for example, generating and staging backups/images/other data usable to configure continuity sites 102 to provide the functionality of production sites 101, (vi) monitor production sites 101 for failures (and/or signs of future failures), and (vii) take action based on the continuity policies when so indicated by the monitoring of production sites 101.

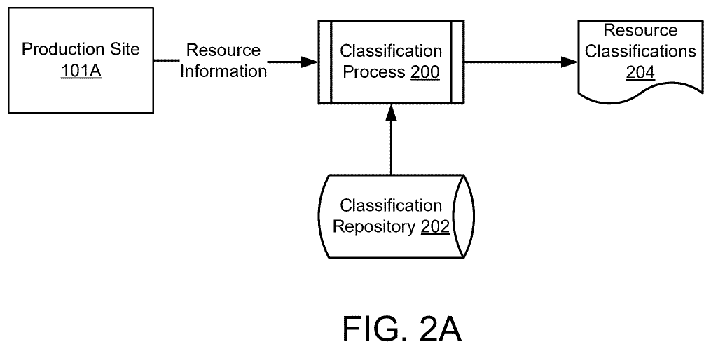

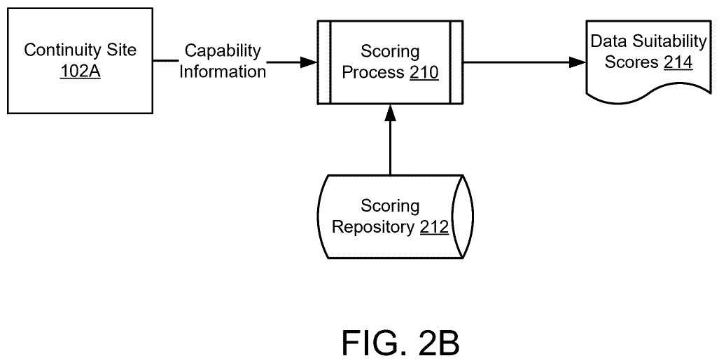

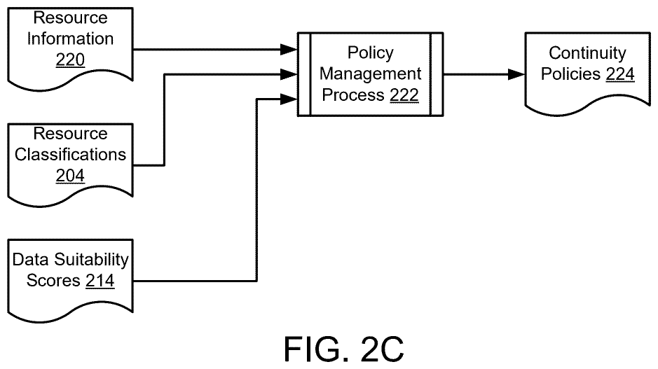

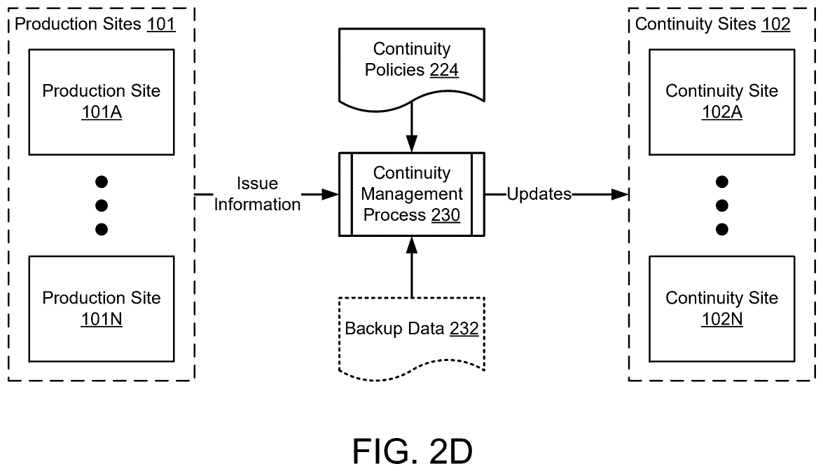

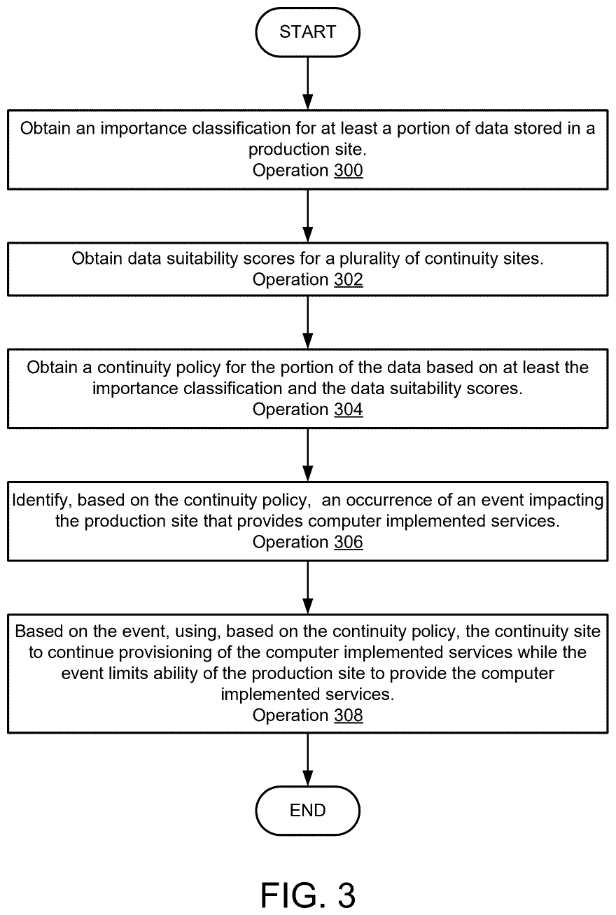

When providing their functionality, any of management system 100, production sites 101, and/or continuity sites 102 (and/or portions thereof) may perform all, or a portion, of the actions, flows, and methods shown in FIGS. 2A-3.

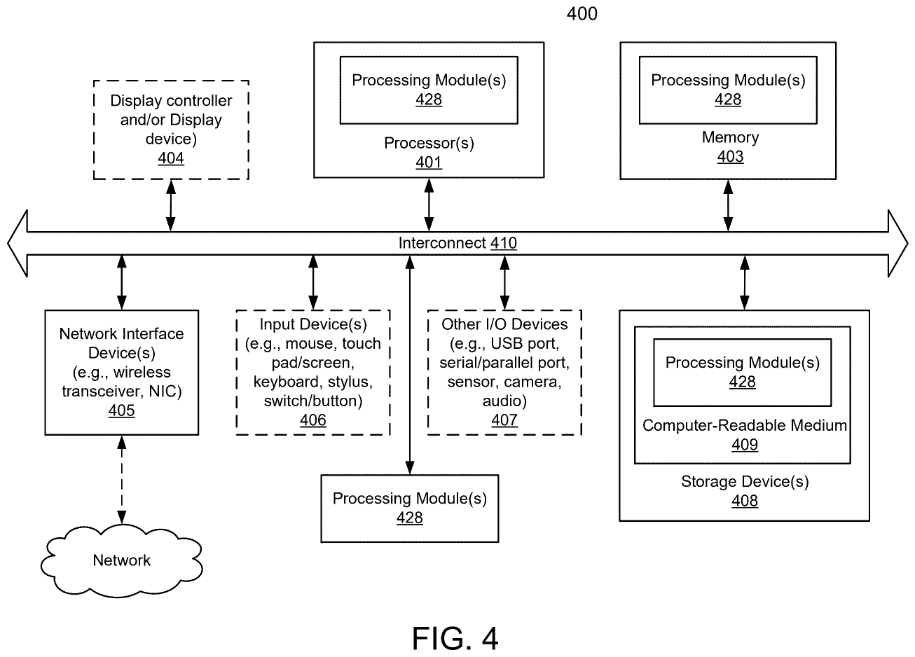

Any of (and/or components thereof) management system 100, production sites 101, and continuity sites 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 204, 214, etc.) is used to represent data structures, a second set of shapes (e.g., 200, 210, etc.) is used to represent processes performed using and/or that generate data, and a third set of shapes (e.g., 202, 212, etc.) is used to represent large scale data structures such as databases.

Turning to FIG. 2A, a first data flow diagram in accordance with an embodiment is shown. The first data flow diagram may illustrate data used in and data processing performed in establishing continuity policies used to manage operation of distributed systems.

To establish continuity policies, classification process 200 may be performed to obtain resource classifications 204 for resources of a production site (e.g., 101A). The resources may be portions of data used by the production site. The portion may be any addressable portion of data. The data may be used by the production site to provide computer implemented services.

During classification process 200, each resource may be classified by (i) obtaining resource information for each corresponding portion of the data, and (ii) using information from classification repository 202 to ascribe (e.g., metadata) a level of importance and a level of sensitivity.

To ascribe a level of importance, classification repository 202 may include importance level classification rules for each portion of data. The importance level classification rules may ascribe levels of importance based on (i) frequency of access of each portion of data by entities, and (ii) values (e.g., weights) ascribed to the respective entities.

For example, various service processes hosted by endpoint devices of production site 101A may be monitored. Each of the service processes may be a microservice that corresponds to an application programming interface of an application hosted by one of the endpoint devices. During operation, the application programming interfaces may receive requests from other entities, and act on the requests. The actions may include, for example, accessing portions of data and sending requests to other application programming interfaces that may, in turn, access portions of data. The aforementioned interaction may be referred to as an access chain.

To obtain the information, each of the endpoint devices may host a reporting framework (e.g., one or more applications) that tracks access of different portions of data, and/or the corresponding access chains. The information collected by the reportion frameworks may be ingested by classification process 200.

Once ingested, a corresponding level of importance of a resource classification of resource classifications may be established. To generate the level of importance, each access of a portion of the data by one of the services processes may be ascribed a value, and the values may be averaged or otherwise combined to ascribe a single quantification as a level of importance for the portion of the data. The value ascribed to each access may be based on an entity that participated in the access (e.g., each entity may be ascribed a value based on a relative level of importance, thus access of a portion of data by different entities may be ascribed different values).

In a first example of rules for establishing the level of importance, the entity may be a last entity in an access chain (e.g., the entity that sent the read/write/delete request). For example, if a first service ascribed a value of 1 issues a request to a second service (e.g., via application programming interfaces) ascribed a value of 0.5 which in turn issues a read request for a portion of data, the access may be given a value of 0.5 because the second service issued the actual access request.

In a second example of rules for establishing the level of importance, the entity may be an entity in the access chain that is ascribed a highest level of importance (e.g., a correspondingly, highest value). For example, if a first service ascribed a value of 1 issues a request to a second service (e.g., via application programming interfaces) ascribed a value of 0.5 which in turn issues a read request for a portion of data, the access may be given a value of 1 because the first service is the highest valued entity in the access chain and is ascribed a value of 1.

In a third example of rules for establishing the level of importance, the entity may be a fictitious entity that is ascribed a value of an average of the values ascribed to the entities in the access chain. For example, if a first service ascribed a value of 1 issues a request to a second service (e.g., via application programming interfaces) ascribed a value of 0.5 which in turn issues a read request for a portion of data, the access may be given a value of 0.75 because the average (e.g., (1+0.5)/2=0.75) of the values ascribed to the two services in the access chain is 0.75.

It will be appreciated that different sets of rules may be used to ascribe values to accesses based on the entities participating in the access chains without departing from embodiments disclosed herein.

Once the values for each of the accesses of a portion of data are obtained, the values themselves may be averaged or otherwise used (e.g., could be a highest value, lowest value, median value, etc.) to ascribe a priority to the portion of data, which may be added to a resource classification of resource classifications 204. The aforementioned process may be repeated for each portion of data.

It will be appreciated that a portion of data may be any ascertainable amount of data such as, for example, a file, a volume used in a file system, an image, etc.

To ascribe values to different entities, information may be read from classification repository 202. Classification repository 02 may include values (e.g., weights) or other information for each entity which may be part of an access chain. The values may be obtained, for example, during development of software corresponding to the service processes, may be evaluated dynamically (e.g., in a complete automated or semi-automated manner, which may include subject matter expert involvement), etc.

In addition to the levels of importance, levels of sensitivity may also be ascribed to each resource. Classification repository 202 may include rules or other information for ascribing a value to each portion of data that represents the level of sensitivity. In an embodiment, the rules ascribe values based on levels of penalties (e.g., administrative such as financial liability, consumer impression such as reputation, etc.) for in advertent access of such portions of data. Thus, portions of data that if access by unauthorized parties may be ascribed a higher level of sensitivity.

Once obtained, resource classifications 204 may be used to establish continuity policies, as further discussed with respect to FIGS. 2B-2C.

Turning to FIG. 2B, a second data flow diagram in accordance with an embodiment is shown. The second data flow diagram may illustrate data used in and data processing performed in establishing continuity policies.

Continuing with the discussion from FIG. 2A, once resource classifications 204 for different portions of data are obtained, scoring process 210 may be performed to obtain data suitability scores 214 for continuity sites. Data suitability scores 214 may be used to rank or order different continuity sites which may be used to facilitate continued provisioning of computer implemented services provided by production sites 101.

During scoring process 210, capability information from different continuity sites (e.g., 102A) may be obtained. In FIG. 2B, capability information flowing from continuity site 102A is shown, but it will be appreciated that capability information for any number of continuity sites may be obtained and used to obtain data suitability scores 214.

Capability information may include (i) first information usable to estimate a likely level of data latency (e.g., time between request for data access and the request being services) for a continuity site, (ii) second information usable to estimate a likely level of data bandwidth (e.g., rate at which data may be moved in and between continuity sites) for the continuity site, and (iii) third information usable to estimate a likely level of data processing (e.g., rate at which computations may be performed) for the continuity site. The capability information may be obtained by requesting it from the respective continuity sites. The capability information may be obtained by having the respective continuity sites perform test workloads which may stress these capabilities and through which the first through third information may be obtained. Each portion of information may be a value that is obtained based on a formula applied to information obtained from the continuity site.

Once the capability information for a continuity site is obtained, the continuity site may be scored and given a classification based on the score. The score for a continuity site may be obtained by applying a set of scoring rules that are keyed to the different portions of the information to obtain an aggregate score. For example, the scoring rules may define an aggregate score based on the values of the capability information corresponding to latency, bandwidth, and processing capability.

Once the aggregate score is obtained, classification rules (e.g., score ranges) may be used to classify the respective continuity site into a classification. The classifications may include (i) edge-optimized (e.g., these areas are well-suited for edge deployment due to low latency requirements, sufficient bandwidth, and robust edge infrastructure.), (ii) edge-compatible (e.g., these areas may require some adjustments to fully optimize for edge computing but are still suitable for deployment), and (iii) not recommended for edge (e.g., these areas are not suitable for edge deployment due to high latency requirements, insufficient bandwidth, or inadequate edge infrastructure).

The resulting data suitability scores 214 may include (i) the capability information, (ii) corresponding scores for the capability information, and/or (iii) classifications based on the scores. Any number of such classifications for any number of continuity sites may be obtained and added to data suitability scores 214.

Once obtained, data suitability scores 214, like resource classifications 204, may be used to establish continuity policies, as further discussed with respect to FIG. 2C.

Turning to FIG. 2C, a third data flow diagram in accordance with an embodiment is shown. The third data flow diagram may illustrate data used in and data processing performed in establishing continuity policies.

To establish continuity policies 224 for production sites 101, policy management process 222 may be performed. During policy management process 222, the continuity sites may be analyzed to identify which continuity site should be used to facilitate continued provisioning of computer implemented services provided by production sites 101.

To analyze the continuity sites, resource information 220, resource classifications 204, and data suitability scores 214 may be obtained. Resource information 220 may include any amount and type of information regarding resources of one or more production sites. To establish continuity policies 224 for the production sites, resource information 220 and resource classifications 204 may be used to discriminate a portion of the continuity sites based on data suitability scores 214.

For example, resource classifications 204 may be used to identify some of the continuity sites that are acceptable. The resource classifications (e.g., levels of importance, level of sensitivity) may be used to identify minimum acceptable classifications. The minimum acceptable classifications for the continuity sites may be set, for example, by a subject matter expert. In an example, the level of importance and level of sensitivity may be added to obtain a single aggregate value which may be used to select the minimum acceptable classifications. The specific binning of aggregates scores to classifications may be set by the subject matter expert.

Once the minimum acceptable classification is identified, the continuity sites may be discriminated into acceptable and unacceptable groups based on classifications (e.g., of data suitability scores 214) ascribed to the continuity sites (e.g., the ascribed classifications may define a hierarchy of classifications for the continuity sites). Any continuity site that is ascribed at least the minimum acceptable classification may be identified as an acceptable target for a corresponding continuity policy. The specific continuity site that is selected from the acceptable group may be selected on other basis (e.g., cost, efficiency, etc.).

Once the target continuity site is established, a corresponding continuity of continuity policies 224 may be established. The resulting continuity policy may specify any of (i) the selected continuity site, (ii) actions to be performed when trigger conditions are met (e.g., instantiating instances of software/data on the selected continuity site), (iii) trigger conditions of the performance of the actions (e.g., the production site becomes unable to or is anticipated to become unable to be performed), (iv) actions to be performed while a subject production site is in good condition (e.g., backing up date for retention and/or recovery), (v) information regarding the subject production site, etc.), etc.

Thus, via the flow shown in FIG. 2C, any number of continuity policies for any number of production sites may be established. As will be discussed with respect to FIG. 2D, the continuity sites and continuity policies may be used to continue provisioning of desired computer implemented services while production sites may be unable to do so.

Turning to FIG. 2D, a fourth data flow diagram in accordance with an embodiment is shown. The fourth data flow diagram may illustrate data used in and data processing performed in managing the provisioning of computer implemented services.

To manage the provisioning of computer implemented services, continuity management process 230 may be performed. During continuity management process 230, the operation of production sites 101 (and/or other entities) may be monitored to identify whether any changes in operations is to be made based on continuity policies 224. For example, operation of production sites 101 may be monitored based on trigger conditions of continuity policies 224. If the operation meets the trigger condition, then it may be concluded that a continuity policy is to be enforced.

When a continuity policy is triggered and to be enforced, operation of one or more of continuity sites 102 may be modified. For example, recovery processes may be performed to instantiate new instances of processes and data that are able to provision the computer implemented services provisioned by production sites 101 may be established. To establish the new instances, backup data 232 for production sites 101 may be used. Backup data 232 may include any type and quantity of data usable to establish the new software/data instances.

For example, backup data 232 may include various images (e.g., disk/entity images) of the data of production sites 101 (and/or portions thereof) at different points in time. When one of production sites 101 becomes unable to provision computer implemented services, the various images may be used to instantiate corresponding software/data instances that can continue to provide the computer implemented services.

Once instantiated and/or configured, the new instances hosted by the corresponding continuity site (e.g., the target as defined by the triggered continuity policy) may begin to provide the computer implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data used in computer implemented services. FIG. 3 illustrates a method that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing a distributed system in accordance with an embodiment is shown. The method may be performed by any of the components of the system of FIG. 1.

At operation 300, an importance classification (e.g., an importance level) for at least a portion of data stored in a production site is obtained. The importance classification may be obtained by (i) identifying a frequency of use of the at least the portion of the data, (ii) identifying entities that used the data, and (iii) using the frequency and entity identities to obtain the importance classification. The importance classification may be quantifications.

A sensitivity classification (e.g., a sensitivity level) for the at least the portion of the data may also be obtained. The sensitivity classification may indicate a level of penalty for an owner of the distributed system should the portion of the data be accessed by unauthorized entities.

At operation 302, data suitability scores for at plurality of continuity sites are obtained. The data suitability scores may be obtained by, for a continuity site of the plurality of continuity sites: obtaining an estimated level of latency for data access in the continuity site; obtaining an estimated level of bandwidth for the data access in the continuity site; obtaining an estimated level of capability to provide the computer implemented services by the continuity site; and combining the estimated level of latency, the estimated level of bandwidth, and the estimated level of capability to obtain a data suitability score of the data suitability scores. For example, as discussed above, a combined aggregate score for each continuity site may be established based on the levels of latency, bandwidth, and capability, which may be individual obtained based on information obtained from the continuity sites. The information may then be ingested into a formula or other entity to establish the levels.

The continuity sites may also be grouped based on the data suitability scores. For example, the groups may correspond to classifications (e.g., “edge ready”, “edge compatible”, etc.).

At operation 304, a continuity policy for the portion of the data is obtained based on the at least the importance classification and the data suitability scores. The continuity policy may be obtained by identify a group of the groups based on at least the importance classification; selecting one of the plurality of continuity sites grouped in the group; and adding the one of the plurality of continuity sites to the continuity policy as a target restoration location.

The group may also be identified based on the sensitivity classification. Different groups may be rated for different importance and/or sensitivity classifications. The may be any of the groups that at least meet the sensitivity and/or importance classifications.

The one from the selected group may be selected on any basis (e.g., cost, efficiency, random selection, etc.).

The selected one may be added by using the one as a target in the continuity policy. Consequently, when the continuity policy is triggered, the one of the continuity sites from the selected group may be used to continue provisioning of computer implemented services.

At operation 306, an occurrence of an event impacting the production site that provides computer implemented is identified. The occurrence may be identified, for example, by monitoring operation of the production site, and comparing the operation to trigger conditions in the continuity policy. The occurrence may also be identified by monitor other sources of information (e.g., weather services, power services, etc. that may issue warnings and/or provide other information regarding conditions that may impact the production site).

At operation 308, based on the event and the continuity policy, the continuity site is used to continue provisioning of the computer implemented services while the event limits ability of the production site to provide the computer implemented services. The continuity site may be used by updating operation of the continuity site (e.g., by instantiating new software/data instances, etc.) to provide the computer implemented services based on the continuity policy.

The method may end following operation 308.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a distributed system, the method comprising:
obtaining an importance classification for at least a portion of data stored in a production
site;
obtaining data suitability scores for a plurality of continuity sites;
obtaining a continuity policy for the portion of the data based on at least the importance classification and the data suitability scores;
identifying, based on the continuity policy, an occurrence of an event impacting the production site that provides computer implemented services; and
based on the event, using, based on the continuity policy, the continuity site to continue provisioning of the computer implemented services while the event limits ability of the production site to provide the computer implemented services.

2. The method of claim 1, wherein obtaining the data suitability scores comprises:
for a continuity site of the plurality of continuity sites:
obtaining an estimated level of latency for data access in the continuity site;
obtaining an estimated level of bandwidth for the data access in the continuity site;
obtaining an estimated level of capability to provide the computer implemented services by the continuity site; and
combining the estimated level of latency, the estimated level of bandwidth, and the estimated level of capability to obtain a data suitability score of the data suitability scores.

3. The method of claim 2, further comprising:
obtaining a sensitivity classification for the at least the portion of data stored in a production site, the sensitivity classification indicating a level of penalty for an owner of the distributed system should the portion of the data be accessed by unauthorized entities.

4. The method of claim 3, wherein the importance classification for the at least the portion of the data indicates an extent to which the computer implemented services would be disrupted when the at least the portion of the data is inaccessible.

5. The method of claim 1, wherein the continuity policy indicates a destination for re-establishing performance of the computer implemented services following the event.

6. The method of claim 5, wherein the continuity policy further indicates at least one action to be performed prior to the occurrence of the event and in response to an occurrence of a second event, the second event indicating an increased likelihood of the occurrence of the event in the future.

7. The method of claim 1, further comprising:
grouping the plurality of continuity sites into groups based on the data suitability scores.

8. The method of claim 7, wherein obtaining the continuity policy comprises:
identify a group of the groups based on at least the importance classification;
selecting one of the plurality of continuity sites grouped in the group; and
adding the one of the plurality of continuity sites to the continuity policy as a target restoration location.

9. A non-transitory machine-readable medium having instructions stored therein, which when executed by a processor, cause operations for managing a distributed system to be performed, the operations comprising:
obtaining an importance classification for at least a portion of data stored in a production site;
obtaining data suitability scores for a plurality of continuity sites;
obtaining a continuity policy for the portion of the data based on at least the importance classification and the data suitability scores;
identifying, based on the continuity policy, an occurrence of an event impacting the production site that provides computer implemented services; and
based on the event, using, based on the continuity policy, the continuity site to continue provisioning of the computer implemented services while the event limits ability of the production site to provide the computer implemented services.

10. The non-transitory machine-readable medium of claim 9, wherein obtaining the data suitability scores comprises:
for a continuity site of the plurality of continuity sites:
obtaining an estimated level of latency for data access in the continuity site;
obtaining an estimated level of bandwidth for the data access in the continuity site;
obtaining an estimated level of capability to provide the computer implemented services by the continuity site; and
combining the estimated level of latency, the estimated level of bandwidth, and the estimated level of capability to obtain a data suitability score of the data suitability scores.

11. The non-transitory machine-readable medium of claim 10, wherein the operations further comprise:
obtaining a sensitivity classification for the at least the portion of data stored in a production site, the sensitivity classification indicating a level of penalty for an owner of the distributed system should the portion of the data be accessed by unauthorized entities.

12. The non-transitory machine-readable medium of claim 11, wherein the importance classification for the at least the portion of the data indicates an extent to which the computer implemented services would be disrupted when the at least the portion of the data is inaccessible.

13. The non-transitory machine-readable medium of claim 9, wherein the continuity policy indicates a destination for re-establishing performance of the computer implemented services following the event.

14. The non-transitory machine-readable medium of claim 13, wherein the continuity policy further indicates at least one action to be performed prior to the occurrence of the event and in response to an occurrence of a second event, the second event indicating an increased likelihood of the occurrence of the event in the future.

15. The non-transitory machine-readable medium of claim 9, wherein the operations further comprise:
grouping the plurality of continuity sites into groups based on the data suitability scores.

16. The non-transitory machine-readable medium of claim 15, wherein obtaining the continuity policy comprises:
identify a group of the groups based on at least the importance classification;
selecting one of the plurality of continuity sites grouped in the group; and
adding the one of the plurality of continuity sites to the continuity policy as a target restoration location.

17. A data processing system, comprising:
a processor; and
a memory coupled to the processor to store instructions, which when executed by the processor, cause operations for managing a distributed system, the operations comprising:
obtaining an importance classification for at least a portion of data stored in a production site;
obtaining data suitability scores for a plurality of continuity sites right respect to the at least the portion of data;
obtaining a continuity policy for the portion of the data based on at least the importance classification and the data suitability scores;
identifying an occurrence of an event impacting the production site that provides computer implemented services; and
based on the event, using the continuity site to continue provisioning of the computer implemented services while the event limits ability of the production site to provide the computer implemented services.

18. The data processing system of claim 17, wherein obtaining the data suitability scores comprises:
for a continuity site of the plurality of continuity sites:
obtaining an estimated level of latency for data access in the continuity site;
obtaining an estimated level of bandwidth for the data access in the continuity site;
obtaining an estimated level of capability to provide the computer implemented services by the continuity site; and
combining the estimated level of latency, the estimated level of bandwidth, and the estimated level of capability to obtain a data suitability score of the data suitability scores.

19. The data processing system of claim 18, wherein the operations further comprise:
obtaining a sensitivity classification for the at least the portion of data stored in a
production site, the sensitivity classification indicating a level of penalty for an owner of the distributed system should the portion of the data be accessed by unauthorized entities.

20. The data processing system of claim 19, wherein the importance classification for the at least the portion of the data indicates an extent to which the computer implemented services would be disrupted when the at least the portion of the data is inaccessible.
